(19) United States
(12) Patent Application Publication
(10) Pub. No.: US 2026/0281651 A1
(43) Pub. Date: Sep. 17, 2026

(54) METHODS, DEVICES, AND SYSTEMS FOR RENDERING CALIBRATED SPATIALIZED AUDIO

(71) Applicant: Bose Corporation, Framingham, MA (US)

(72) Inventors: David Dick, Marlborough, MA (US); Wade P. Torres, Attleboro, MA (US); Daniel Tengelsen, Framingham, MA (US)

(73) Assignee: Bose Corporation, Framingham, MA (US)

(21) Appl. No.: 19/081,303

(22) Filed: Mar. 17, 2025

(51) Int. Cl. H04S 7/00; G06F 3/04847

(52) U.S. Cl. CPC H04S 7/303; G06F 3/04847

(57) ABSTRACT

A method for rendering calibrated spatialized audio is provided. The method includes rendering, via an acoustic transducer, calibration audio based on an initial head-related transfer function (HRTF). The initial HRTF corresponds to an initial azimuth angle and an initial elevation angle. The initial HRTF includes one or more HRTF filters corresponding to a user. The method further includes generating a calibrated HRTF based on applying a warping parameter to least one of the initial azimuth angle, the initial elevation angle, and the initial HRTF. The method further includes rendering, via the acoustic transducer, the calibrated spatialized audio based on the calibrated HRTF and output audio data. In some examples, the method also includes receiving, via a user interface, the warping parameter provided in response to the calibration audio.

### FIELD OF THE DISCLOSURE

This disclosure relates to methods, devices, and systems for rendering calibrated spatialized audio, and more particularly, to adjusting a virtual location of a virtual audio source.

### BACKGROUND

Audio content may be provided in immersive, spatialized, and three-dimensional formats. Spatializing the audio content results in the audio sounding as if it is coming from the surrounding environment, even if the audio is generated by a wearable audio device, such as audio headphones or a set of earbuds.

### SUMMARY

Spatialized audio is rendered in part based on head-related transfer functions (HRTFs). HRTFs include a plurality of filters representing the impact of the physical structure of the head of a user (including the structure of their external ear or pinna) on sound received from an external source. Accordingly, HRTFs are dependent on the geometry of the head of the user. However, conventional implementations of HRTFs use a generic HRTF. The generic HRTF may be programmed into an audio device during manufacturing and can be set based on measurements taken on a dummy head containing a set of binaural microphones. These generic HRTFs provide sufficient spatialization for most users. However, outlier users may have a head shape (such as an external ear shape) resulting in an HRTF significantly different than the generic HRTF. These differences may result in sound localization errors, most commonly experienced as the virtual sound source sounding as if it is arranged at a very high elevation angle, rather than along the horizontal plane.

The present disclosure is generally directed to methods, devices, and systems rendering calibrated spatialized audio to correct for the aforementioned localization errors. Calibration audio is rendered by an acoustic transducer of an audio device. The calibration audio is generated based on an initial HRTF (comprising an initial set of HRTF filters) corresponding to an initial azimuth angle and an initial elevation angle. The initial azimuth angle and the initial elevation angle are generated based on head orientation data and head location data corresponding to the head of the user, and virtual sound source location data corresponding to the desired virtual location of the virtual sound source. The initial HRTF refers to an HRTF prior to calibration. As the head of the user moves, the initial azimuth angle and the initial elevation angle are dynamically updated. Accordingly, the initial HRTF corresponding to the initial azimuth and elevation angles is similarly dynamically updated.

In response to hearing the calibration audio, a user enters a warping parameter (which may include a plurality of warping parameters) as a user input into a user interface. The user may enter their user input via one or more warping sliders, a two-dimensional warping field, or a tournament interface. The warping parameter is then used to generate a calibrated HRTF. In some examples, the calibrated HRTF is generated by applying the warping parameter to the initial HRTF. In other examples, the warping parameter is applied to the initial elevation and azimuth angles to generate warped elevation and azimuth angles. An HRTF lookup table then uses the warped elevation and azimuth angles to retrieve the calibrated HRTF. In even further examples, the warping parameter is applied to the HRTF lookup table to generate a warped lookup table. The warped lookup table then uses the initial elevation and azimuth angles to retrieve the calibrated HRTF. The calibrated HRTF is then applied to output audio data to generate calibrated spatialized audio data, which is rendered by the acoustic transducer. Further, as the user continues to move their head, the initial azimuth and elevation angles are dynamically updated, causing the warped elevation and azimuth angles and the calibrated HRTF to be similarly dynamically updated.

Generally, in one aspect, a method for rendering calibrated spatialized audio is provided. The method includes rendering, via an acoustic transducer, calibration audio based on an initial HRTF. The initial HRTF corresponds to an initial azimuth angle and an initial elevation angle. The initial HRTF includes one or more HRTF filters corresponding to a user.

The method further includes generating a calibrated HRTF based on applying a warping parameter to least one of the initial azimuth angle, the initial elevation angle, and the initial HRTF.

The method further includes rendering, via the acoustic transducer, the calibrated spatialized audio based on the calibrated HRTF and output audio data.

According to an example, the calibrated HRTF is generated by: (1) generating a warped azimuth angle based on the initial azimuth angle and the warping parameter; (2) generating a warped elevation angle based on the initial elevation angle and the warping parameter; and (3) retrieving the calibrated HRTF based on the warped azimuth angle and the warped elevation angles.

According to an example, the initial azimuth angle and the initial elevation angle are determined based on head orientation data, head location data, and/or virtual sound source location data.

According to an example, the method further includes receiving, via a user interface, the warping parameter provided in response to the calibration audio.

According to an example, the user interface displays a warping slider configured to capture the warping parameter.

According to an example, the user interface displays a two-dimensional warping field configured to capture the warping parameter.

According to an example, the user interface displays a tournament interface configured to capture the warping parameter.

According to an example, the warping parameter comprises a plurality of warping parameters.

According to an example, the plurality of warping parameters includes an elevation warping parameter and an azimuth warping parameter.

According to an example, the calibration audio comprises an audio tone, entertainment audio, a noise burst, and/or a user instruction.

Generally, in another example, an audio system is provided. The audio system includes a controller. The controller is configured to render, via an acoustic transducer, calibration audio based on an initial HRTF. The initial HRTF corresponds to an initial azimuth angle and an initial elevation angle. The initial HRTF includes one or more HRTF filters corresponding to a user.

The controller is further configured to generate a calibrated HRTF based on applying a warping parameter to least one of the initial azimuth angle, the initial elevation angle, and the initial HRTF.

The controller is further configured to render, via the acoustic transducer, the calibrated spatialized audio based on the calibrated HRTF and output audio data.

According to an example, the calibrated HRTF is generated by: (1) generating a warped azimuth angle based on the initial azimuth angle and the warping parameter; (2) generating a warped elevation angle based on the initial elevation angle and the warping parameter; and (3) retrieving the calibrated HRTF based on the warped azimuth angle and the warped elevation angles.

According to an example, the initial azimuth angle and the initial elevation angle are determined based on head orientation data, head location data, and/or virtual sound source location data.

According to an example, the audio system further includes a user interface configured to receive the warping parameter provided in response to the calibration audio.

According to an example, the user interface displays a warping slider configured to capture the warping parameter.

According to an example, the user interface displays a two-dimensional warping field configured to capture the warping parameter.

According to an example, the user interface displays a tournament interface configured to capture the warping parameter.

According to an example, the warping parameter comprises a plurality of warping parameters.

According to an example, the plurality of warping parameters includes an elevation warping parameter and an azimuth warping parameter.

According to an example, the calibration audio comprises an audio tone, entertainment audio, a noise burst, and/or a user instruction.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view illustrating head related transforms (HRTFs) characterizing sound received by a user, in accordance with the present disclosure.

FIG. 2 is a schematic view illustrating an elevation angle of a virtual audio source relative to a user, in accordance with the present disclosure.

FIG. 3 is a schematic view illustrating an azimuth angle of a virtual audio source relative to a user, in accordance with the present disclosure.

FIG. 4 is a diagram of aspects of an audio system for rendering calibrated spatialized audio, in accordance with the present disclosure.

FIG. 5 is a schematic view of an audio device, in accordance with the present disclosure.

FIG. 6A is a functional block diagram of aspects of the audio device, in accordance with the present disclosure.

FIG. 6B is a variation of the functional block diagram of FIG. 6A, in accordance with the present disclosure.

FIG. 6C is a variation of the functional block diagrams of FIGS. 6A and 6B, in accordance with the present disclosure.

FIG. 7 illustrates a user interface displaying a pair of warping sliders to receive a warping parameter, in accordance with the present disclosure.

FIG. 8 illustrates a user interface displaying a two-dimensional warping field to receive a warping parameter, in accordance with the present disclosure.

FIG. 9 illustrates a user interface displaying a tournament interface to receive a warping parameter, in accordance with the present disclosure.

FIG. 10 illustrates a series of warping curves, in accordance with the present disclosure.

FIG. 11 is a flowchart illustrating a method for rendering calibrated spatialized audio, according to the present disclosure.

### DETAILED DESCRIPTION

The present disclosure is generally directed methods, devices, and systems rendering calibrated spatialized audio to correct for localization errors. Calibration audio is rendered by an acoustic transducer of an audio device. The calibration audio is generated based on an initial HRTF corresponding to an initial azimuth angle and an initial elevation angle. The initial azimuth angle and the initial elevation angle are generated based on head orientation data and head location data corresponding to the head of the user, and virtual sound source location data corresponding to the desired virtual location of the externalized virtual sound source. In response to hearing the calibration audio, a user enters a warping parameter as a user input into a user interface. The warping parameter is then used to generate a calibrated HRTF. The calibrated HRTF is then applied to output audio data to generate calibrated spatialized audio data, which is rendered by the acoustic transducer.

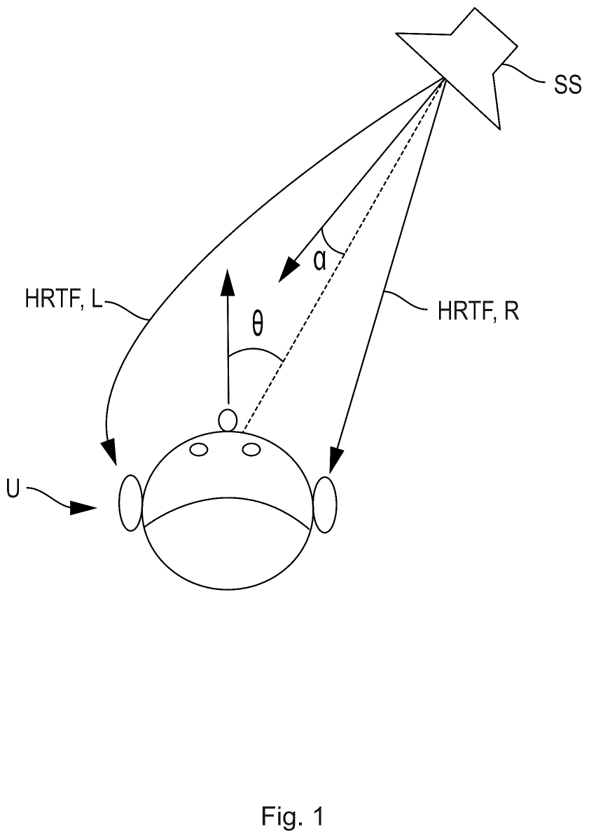

The following description should be read in view of FIGS. 1-11.

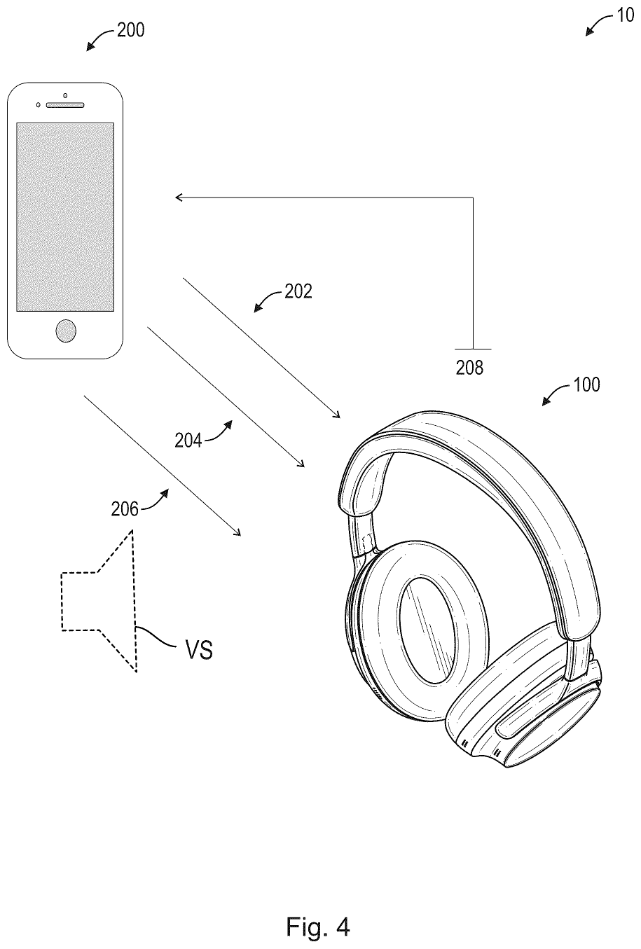

The term “wearable audio device,” as used in this application, in addition to including its ordinary meaning or its meaning known to those skilled in the art, is intended to mean a device that fits around, on, in, or near an ear (including open-ear audio devices worn on the head or shoulders of a user) and that radiates acoustic energy into or towards the ear. Wearable audio devices are sometimes referred to as headphones, earphones, earpieces, headsets, earbuds, or sport headphones, and can be wired or wireless. A wearable audio device includes an acoustic driver to transduce audio signals to acoustic energy. The acoustic driver can be housed in an earcup. While some of the figures and descriptions following can show a single wearable audio device, having a pair of earcups (each including an acoustic driver) it should be appreciated that a wearable audio device can be a single stand-alone unit having only one earcup. Each earcup of the wearable audio device can be connected mechanically to another earcup or headphone, for example by a headband and/or by leads that conduct audio signals to an acoustic driver in the earcup or headphone. A wearable audio device can include components for wirelessly receiving audio signals. A wearable audio device can include components of an active noise reduction (ANR) system. Wearable audio devices can also include other components such as a microphone so that they can function as a headset. While the non-limiting example of FIG. 4 depicts an audio device 100 as a pair of audio headphones, the audio device 100 described below may be any of the aforementioned types of devices. Further, the features described herein may be implemented in a non-wearable device or system, such as, but not limited to, off-the-head binaural playback audio systems employing cross-talk cancellation, such as binaural automotive audio systems or a binaural audio system employing soundbars.

The term “head related transfer function” or acronym “HRTF” is intended to be used broadly herein to reflect any manner of calculating, determining, or approximating head related transfer functions. For example, a head related transfer function as referred to herein may be generated or selected specific to each user, e.g., taking into account that user's unique physiology (e.g., size and shape of the head, ears, nasal cavity, oral cavity, etc.). Alternatively, a generalized head related transfer function may be generated or selected that is applied to all users, or a plurality of generalized head related transfer functions may be generated that are applied to subsets of users (e.g., based on certain physiological characteristics that are at least loosely indicative of that user's unique head related transfer function, such as age, gender, head size, ear size, or other parameters). In one embodiment, certain aspects of the head related transfer function may be accurately determined, while other aspects are roughly approximated (e.g., accurately determines the inter-aural delays, but coarsely determines the magnitude response). In various examples, a number of HRTF's may be stored, e.g., in a memory, and selected for use relative to a determined angle of arrival of a virtual acoustic signal.

FIG. 1 schematically illustrates a user U receiving sound from a sound source SS. As noted above, HRTFs can be calculated that characterize how the user U receives sound from the sound source SS, and are represented by arrows as a left HRTF, L and a right HRTF, R (collectively or generally HRTFs). The HRTFs are at least partially defined based on an orientation of the user with respect to an arriving acoustic wave emanating from the sound source, indicated by an angle θ. That is, the angle θ represents the relation between the direction that the user U is facing with respect to the direction from which the sound arrives (represented by a dashed line). Directionality of the sound produced by the sound source SS may be defined by a radiation pattern, which varies with the angle α, that represents the relation between the primary (or axial) direction in which the sound source SS is producing sound and the direction to which the user U is located.

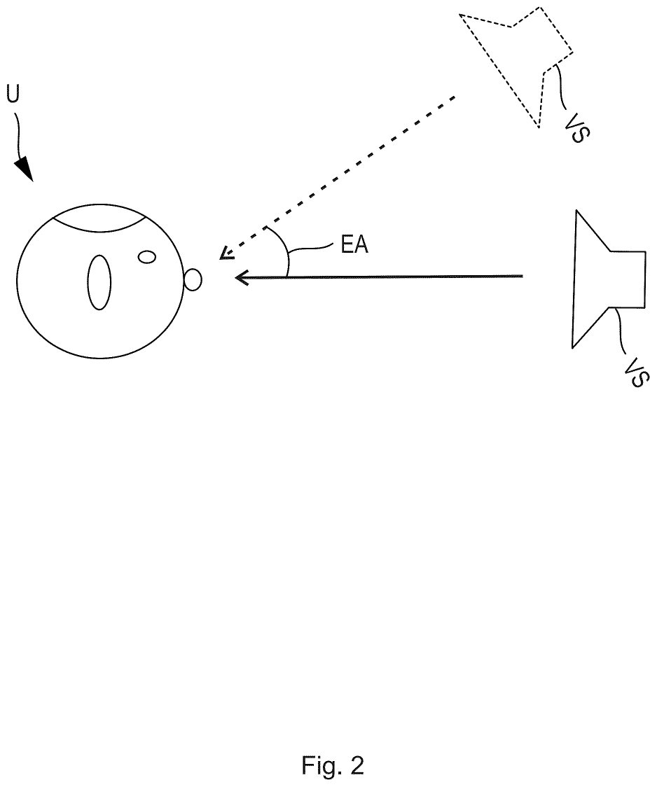

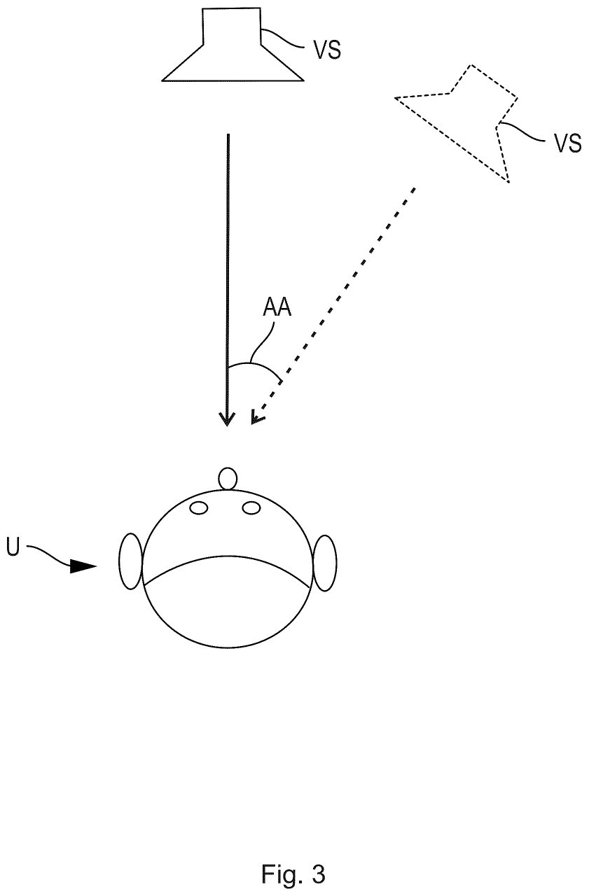

FIGS. 2 and 3 illustrates an elevation angle EA and an azimuth angle AA of an externalized virtual source VS relative to a user U. In this example, an audio system generates spatialized audio resulting in the user U experiencing the audio as if generated by virtual source VS at a virtual location. Thus, even if the audio is generated by a wearable audio device, such as earbuds or headphones, the audio will sound as if it was generated externally. This externalization is achieved by processing an audio signal via an HRTF representing the path the audio would travel to reach the user U from the virtual location. In the example of FIG. 2, the virtual location of the virtual sound source VS is defined by the elevation angle EA. Further, in the example of FIG. 3, the virtual location of the virtual sound source VS is defined by the azimuth angle AA. As previously noted, conventional sound externalization systems use a generic HRTF to generate spatialized audio. Thus, if an HRTF associated with a head of the user U significantly varies from the generic HRTF, localization errors can occur, and the virtual sound source VS may sound as if it is originating from a different elevation angle EA or azimuth angle AA than intended. In particular, certain users may experience significantly higher elevation angles EA due to this HRTF-mismatch. In this situation, a virtual source VS intended to sound as though it is in front of the user U at eye level may actually sound as if it is much higher vertically than the user U.

FIG. 4 illustrates an example audio system 10 to render calibrated spatialized audio. The audio system 10 includes an audio device 100 and an external device 200. The audio rendered by the audio device 100 will be externalized to sound as if it were provided by virtual sound source VS. In the example of FIG. 4, the audio device 100 is depicted as audio headphones. However, in other examples, the audio device 100 may be another type of wearable audio device, such as earbuds, audio eyeglasses, open ear headphones, etc. In further examples, the audio device 100 may instead be a non-wearable device or system, such as a binaural automotive audio system or a binaural audio systems employing soundbars.

Further to the example of FIG. 4, the audio system 10 includes an external device 200. In the example of FIG. 4, the external device 200 is depicted as a smartphone. However, in other examples, the external device 200 may be any device capable of communicating with the audio device 100 via wired or wireless communication. In some examples, the wireless communication may be provided via Bluetooth protocol.

In the example of FIG. 4, the external device 200 transmits output audio data 202 and virtual sound source location data 204 to the audio device 100. The output audio data 202 corresponds to the output audio the user U wishes to hear. The output audio data 202 could correspond to streaming music, telephone call audio, video game soundtrack, etc. The output audio data 202 could include multiple audio channels, such as left stereo channel audio and right stereo channel audio. The virtual sound source location data 204 corresponds to the desired virtual location of the virtual source VS.

The external device 200 also transmits a warping parameter 206 to the audio device 100. As will be described below, the warping parameter 206 is used by the audio device 100 to correct the localization errors described with respect to FIGS. 2 and 3. The warping parameter 206 is generated by the external device 200 based on a user input 208 received via a user interface of the external device 200.

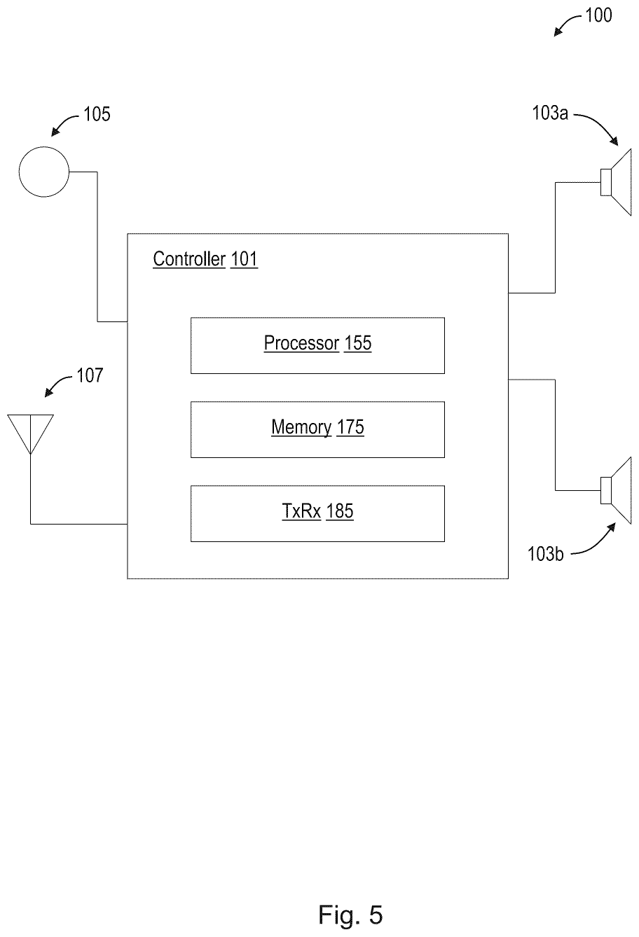

FIG. 5 is a schematic representation of the audio device 100 of FIG. 4. As shown in the non-limiting example of FIG. 5, the audio device 100 includes a controller 101. The controller 101 includes a processor 155 for processing data, a memory 175 for storing data, and a transceiver 185 for transmitting and/or receiving data via an antenna 107. For example, the transceiver 185 may be used to receive the spatialized audio signal 202 and/or the warping parameter 206 transmitted by the external device 200 as shown in FIG. 4. The audio device 100 further includes a left acoustic transducer 103a, a right acoustic transducer 103b, and an orientation sensor 105. The left and right acoustic transducers 103a, 103b are used to provide output audio to the left and right ears of the listener, respectively. For example, the left acoustic transducer 103a may be arranged in a left earcup to be worn over the left ear, while the right acoustic transducer 103b may be arranged in a right earcup to be worn over the right ear. The orientation sensor 105 is used to track the orientation of the head of the listener, and may be arranged at any practical location on the audio device 100. While the non-limiting example of FIG. 5 may represent the audio device 100 as a wearable audio device, in other examples, the features shown in FIG. 5 may be implemented by a non-wearable device or system, such as a binaural automotive audio system or a binaural audio system employing soundbars.

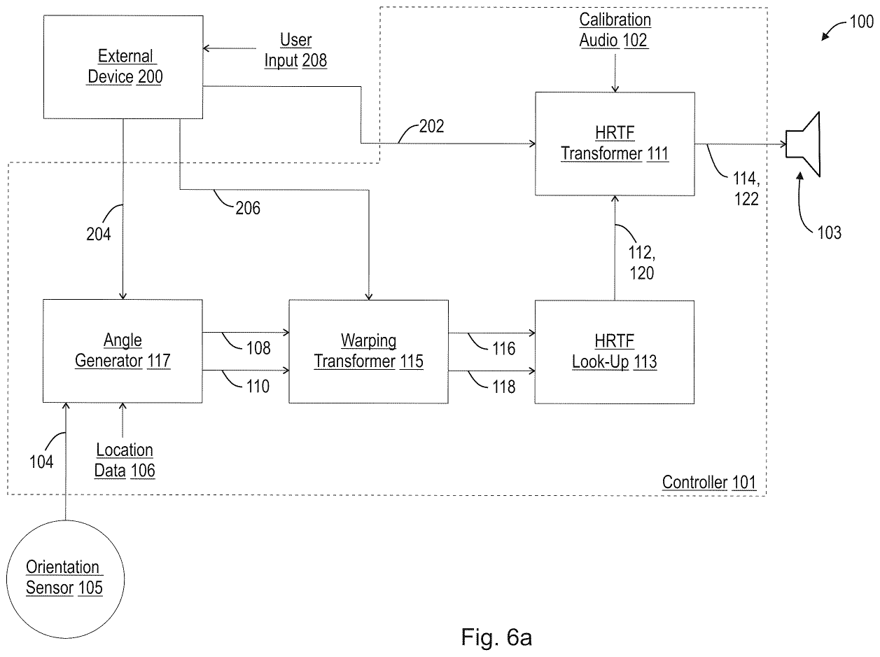

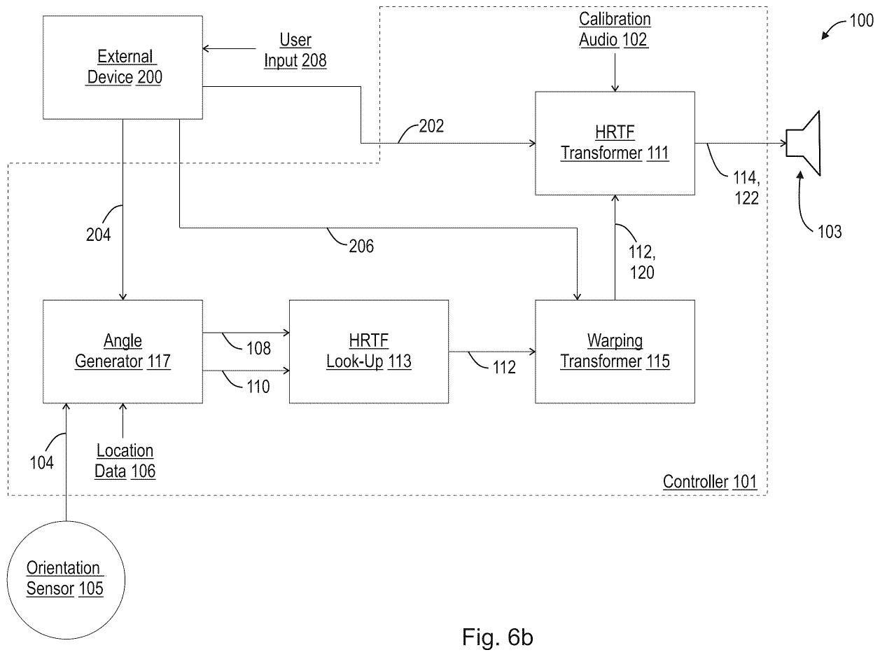

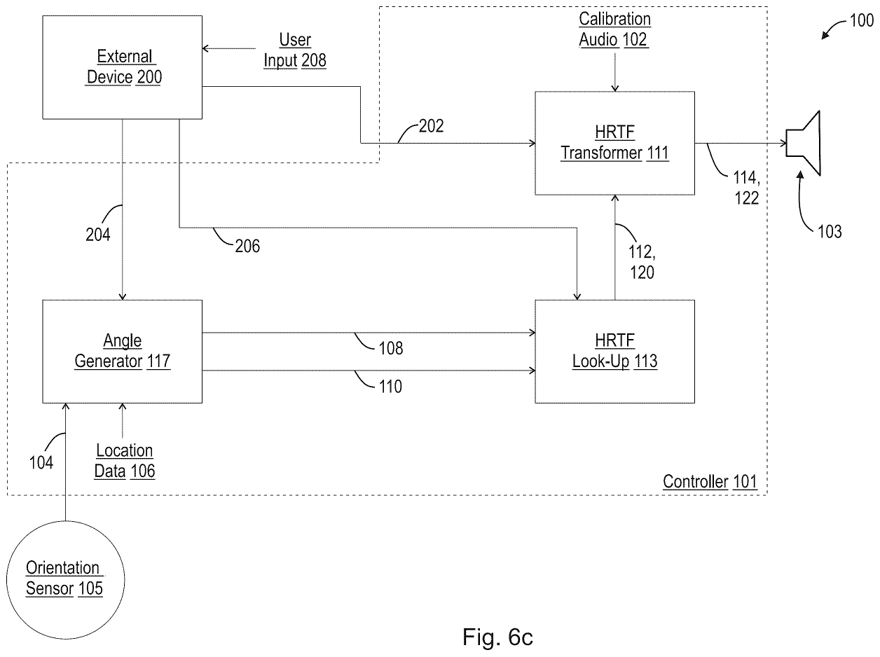

FIG. 6A is a functional block diagram of aspects of the audio device 100. As shown in FIG. 6A, the audio device 100 includes a controller 101, an acoustic transducer 103, and an orientation sensor 105. The aspects of the controller 101 may be performed by one or more processors 155 (such as digital signal processors) on data retrieved from one or more memories 175. While only one acoustic transducer 103 is depicted in FIG. 6A for clarity purposes, the audio device 100 may include two or more acoustic transducers 103, such as the pair of acoustic transducers 103a, 103b shown in FIG. 5. Further, as was illustrated in FIG. 4, the audio device 100 is configured to communicate with external device 200 via a wireless connection, such as via Bluetooth protocol.

In the non-limiting example of FIG. 6A, calibration audio data 102 is retrieved from a memory 175, such as the memory 175 shown in FIG. 5. The calibration audio data 102 may correspond to a wide variety of different types of audio, such as an audio tone, entertainment audio (music, audiovisual soundtrack, podcasts, etc.), a noise burst, a user instruction, or any other type of test signal. For example, the user instruction may inform the user that a calibration process is under way and to take one or more steps to complete the calibration process.

The calibration audio data 102 is then externalized into spatialized calibration audio 114 via an HRTF transformer 111 according to an initial HRTF 112 comprising an initial set of HRTF filters. The acoustic transducer 103 then renders externalized audio for the user to hear based on the spatialized calibration audio 114. However, as previously discussed, the initial HRTF 112 is conventionally a generic HRTF, which may lead to localization errors for some users. In particular, the externalized audio may sound as if it was rendered very high in elevation above the user, when the intent of the initial HRTF 112 was to render audio as though it were at eye level.

In the non-limiting example of FIG. 6A, the initial HRTF 112 is retrieved from an HRTF look-up table 113 according to an initial elevation angle 108 and an initial azimuth angle 110. The initial elevation angle 108 and the initial azimuth angle 110 are geometrically calculated by an angle generator 117 based on head orientation data 104, head location data 106, and/or virtual sound source location data 204. The head orientation data 104 represents the rotational orientation of the head of the user listening to the audio rendered by the acoustic transducer 103, and may be provided by an orientation sensor 105, such as an inertial measurement unit (IMU). The head location data 106 represents the spatial or translational location of the head of the user. The head location data 106 may be retrieved from the memory 175, or it may be retrieved from a sensor tracking the location of the head of the user. The virtual sound source location data 204 represents the desired location in virtual space for the externalized audio to originate. The virtual sound source location data 204 may be provided from the external device 200 or it may be retrieved from memory 175. Further, as the head of the user moves, the initial elevation angle 108 and the initial azimuth angle 110 are dynamically updated based on the aforementioned data. Accordingly, the initial HRTF 112 corresponding to the initial elevation and azimuth angles 108, 110 is similarly dynamically updated.

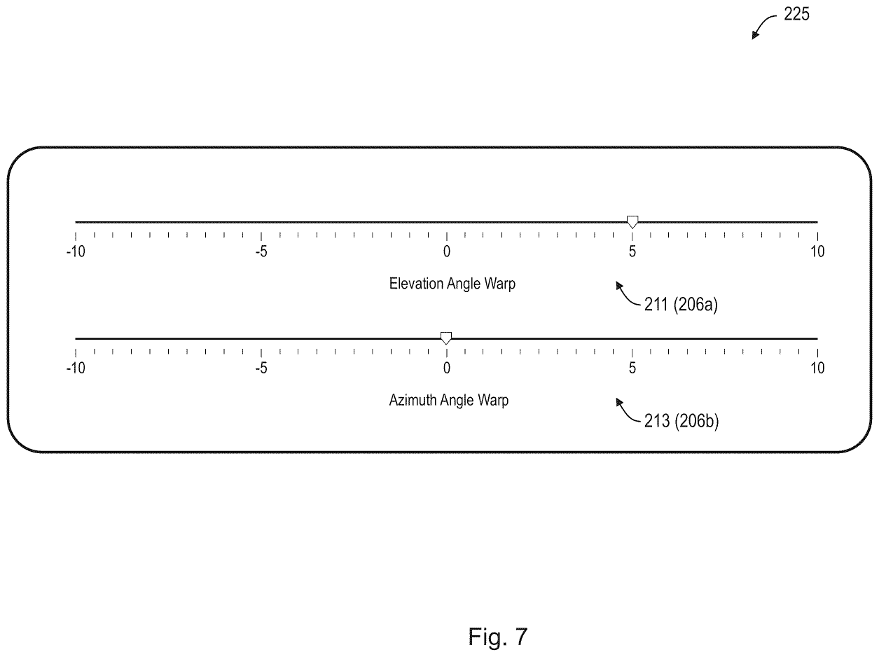

When the spatialized calibration audio 114 is rendered by the acoustic transducer 103, the user may wish to calibrate external audio to adjust the associated elevation angle and/or azimuth angle. In the non-limiting example of FIG. 6A, this calibration may be performed by entering a user input 208 into a user interface 225 of the external device 200. Example user interfaces 225 are shown in FIGS. 7-9. The user input 208 is translated by the external device into a warping parameter 206 and transmitted to the audio device 100. The warping parameter 206 is used to adjust the HRTF used by the HRTF transformer 111. In other examples, the warping parameter 206 may be generated automatically by the controller 101 as a feedback process based by processing the audio generated by the acoustic transducer 103 based on the spatialized calibration audio 114.

In the non-limiting example of FIG. 6A, the initial elevation angle 108, the initial azimuth angle 110, and the warping parameter 206 are provided to a warping transformer 115. The warping transformer 115 adjusts the initial elevation angle 108 and the initial azimuth angle 110 according to the warping parameter 206 to generate a warped elevation angle 116 and a warped azimuth angle 118. In some examples, the warping parameter 206 may include multiple warping parameters 206, such as an elevation warping parameter and/or an azimuth warping parameter. The warped elevation angle 116 and the warped azimuth angle 118 are then provided to the HRTF look-up table 113, which retrieves a calibrated HRTF 120 based on the warped elevation angle 116 and the warped azimuth angle 118. The HRTF transformer 111 then transforms the output audio data 202 provided by the external device 200 to generate calibrated spatialized audio 122. The calibrated spatialized audio 122 is then rendered by the acoustic transducer 103 for the user to hear. In some examples, only the initial elevation angle 108 is warped by the warping transformer 115, such that the calibrated HRTF 120 is retrieved based on the warped elevation angle 116 and the initial azimuth angle 110. Further, as the user continues to move their head, the initial azimuth and elevation angles 108, 110 are dynamically updated, causing the warped elevation and azimuth angles 116, 118 and the calibrated HRTF 120 to be similarly dynamically updated. Accordingly, the user may move their head into a variety of positions to determine if their user input 208 sufficiently calibrated the calibrated spatialized audio 122. If not, the user may enter a new user input 208 to continue the calibration process.

In other examples, and as shown in FIG. 6B, rather than using the warping parameter 206 to adjust the initial elevation angle 108 and/or the initial azimuth angle 110, the warping parameter 206 may be used to directly adjust the initial HRTF 112. In this example, the initial HRTF 112 and the warping parameter 206 may be provided to the warping transformer 115, which directly generates the calibrated HRTF 120. Prior to receiving the warping parameter 206 (such as before the user has entered a user input 208), the warping transformer 115 may simply pass on the uncalibrated initial HRTF 112 to the HRTF transformer 111.

In even further examples, and as shown in FIG. 6C, the warping parameter 206 may be used to adjust the HRTF look-up table 113. In this example, the various entries of the HRTF look-up table 113 may be adjusted by the warping parameter 206, such that, when provided with the initial elevation angle 108 and initial azimuth angle 110, the HRTF look-up table 113 retrieves the calibrated HRTF 120.

FIG. 7 illustrates a user interface 225 displaying a pair of warping sliders 211, 213 to receive a pair of warping parameters 206a, 206b. In this example, the user interface 225 may be a display screen, such as a touch screen of a computing device (such as a smartphone or tablet computer). The user interface 225 displays an elevation warping slider 211 configured to capture an elevation warping parameter 206a and an azimuth warping slide 213 configured to capture an azimuth warping parameter 206b. As can be seen in FIG. 7, the user has entered an elevation warping parameters 206a of 5, and an azimuth warping parameter 206b of 0.

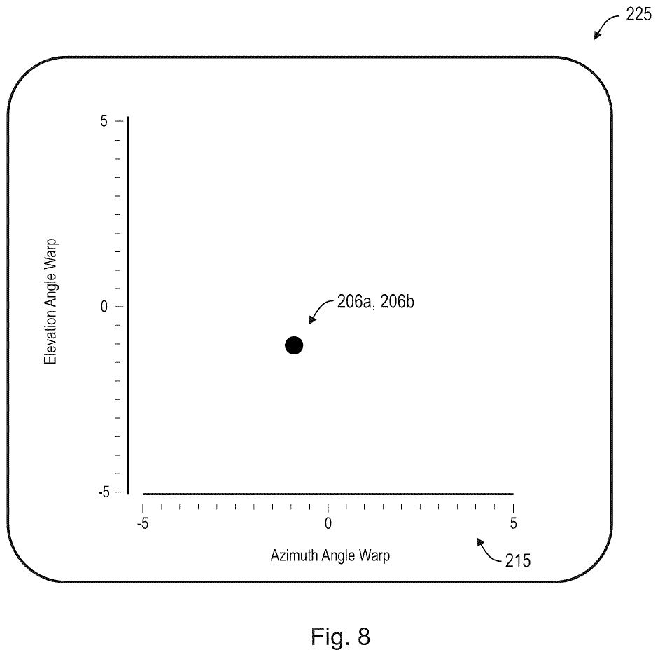

FIG. 8 illustrates a variation of the user interface 225 of FIG. 7 displaying a two-dimensional warping field 215. In this example, rather than controlling two different sliders, a user may enter a single user input 208 into the two-dimensional warping field to capture an elevation warping parameter 206a and an azimuth warping parameter 206b. As can be seen in FIG. 7, the user has entered an elevation warping parameters 206a of −1, and an azimuth warping parameter 206b of −1.

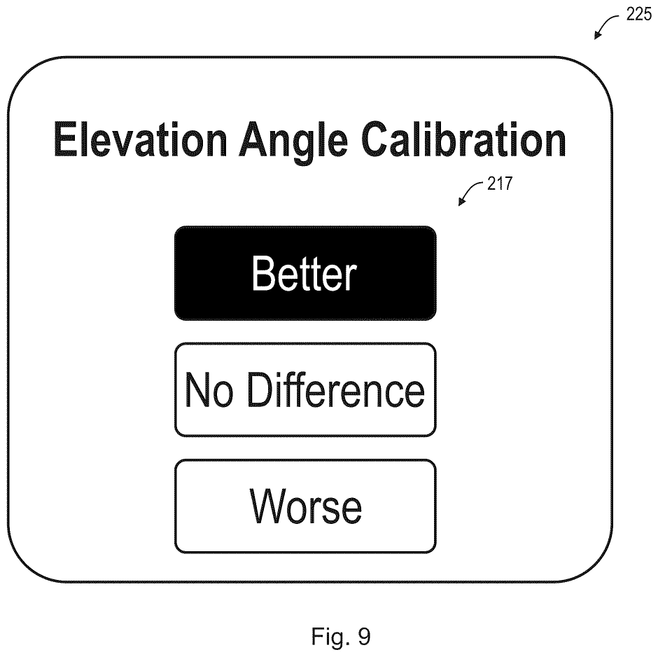

FIG. 9 illustrates another variation of the user interface 225. In this example, the user interface 225 displays a tournament interface 217 where a user iteratively indicates whether a recent adjustment to the calibrated spatialized audio 122 provided “better” calibration, “worse” calibration, or “no difference.” If the “better” or “worse” is selected, a warping parameter 206 is generated to further adjust the calibrated spatialized audio 122. If “no difference” is selected, the calibration process may end, and no further warping parameters 206 are generated.

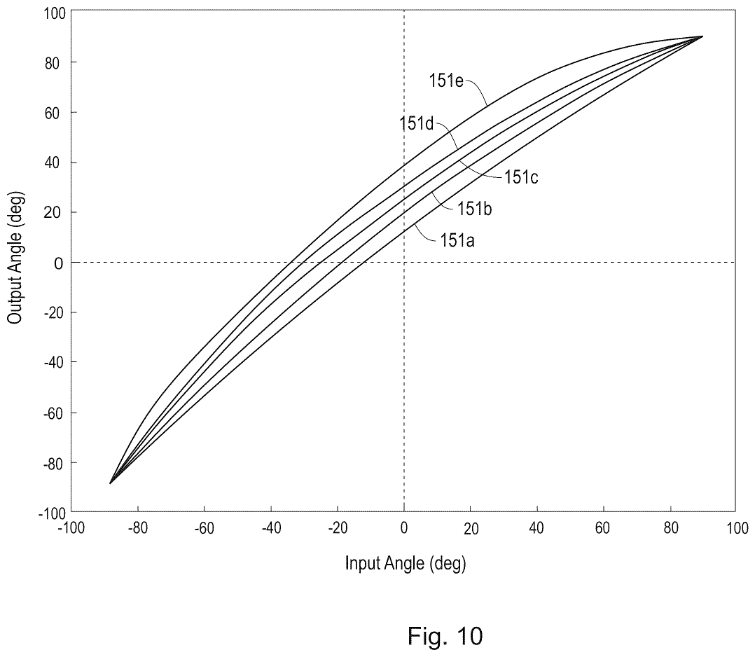

FIG. 10 illustrates a non-limiting example of a series of warping curves 151a-151e. These warping curves 151a-151e indicate the output angle generated from a corresponding input angle. For example, warping curve 151a is used to process an initial elevation angle 108 of 10 degrees, the warped elevation angle 116 will be approximately 22 degrees. The warping curves 151a-151e used to warp the initial elevation angle 108 and/or the initial azimuth angle 110 are chosen based on the warping parameter 206, and different warping curves 151a-151e may be used to warp each of the initial elevation angle 108 and/or the initial azimuth angle 110. The warping curves 151a-151e of FIG. 10 may be generated according to pchip interpolation, however any other appropriate algorithms may be used.

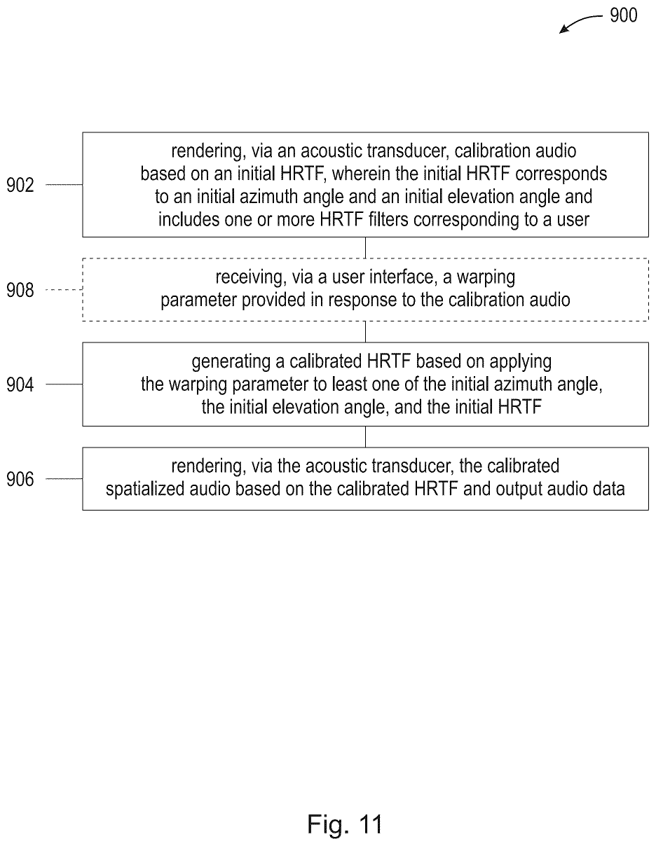

FIG. 11 is an example flow chart of a method 900 for rendering calibrated spatialized audio 122. Referring to FIGS. 1-11, the method 900 includes rendering, via an acoustic transducer 103, calibration audio based on an initial HRTF 112. The initial HRTF 112 corresponds to an initial azimuth angle 110 and an initial elevation angle 108. The initial HRTF 112 includes one or more HRTF filters corresponding to a user.

The method 900 further includes, in step 904, generating a calibrated HRTF 120 based on applying a warping parameter 206 to least one of the initial azimuth angle 110, the initial elevation angle 108, and the initial HRTF 112.

The method 900 further includes, in step 906, rendering, via the acoustic transducer 103, the calibrated spatialized audio based on the calibrated HRTF 120 and output audio data 202.

According to an example, the method 900 further includes, in optional step 908, receiving, via a user interface 225, the warping parameter 206 provided in response to the calibration audio.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software, or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

1. A method for rendering calibrated spatialized audio, comprising:
rendering, via an acoustic transducer, calibration audio based on an initial head-related transfer function (HRTF), wherein the initial HRTF corresponds to an initial azimuth angle and an initial elevation angle and comprises one or more HRTF filters corresponding to a user;
generating a calibrated HRTF based on applying a warping parameter to least one of the initial azimuth angle, the initial elevation angle, and the initial HRTF; and
rendering, via the acoustic transducer, the calibrated spatialized audio based on the calibrated HRTF and output audio data.

2. The method of claim 1, wherein the calibrated HRTF is generated by:
generating a warped azimuth angle based on the initial azimuth angle and the warping parameter;
generating a warped elevation angle based on the initial elevation angle and the warping parameter; and
retrieving the calibrated HRTF based on the warped azimuth angle and the warped elevation angles.

3. The method of claim 1, wherein the initial azimuth angle and the initial elevation angle are determined based on head orientation data, head location data, and/or virtual sound source location data.

4. The method of claim 1, further comprising receiving, via a user interface, the warping parameter provided in response to the calibration audio.

5. The method of claim 4, wherein the user interface displays a warping slider configured to capture the warping parameter.

6. The method of claim 4, wherein the user interface displays a two-dimensional warping field configured to capture the warping parameter.

7. The method of claim 4, wherein the user interface displays a tournament interface configured to capture the warping parameter.

8. The method of claim 1, wherein the warping parameter comprises a plurality of warping parameters.

9. The method of claim 8, wherein the plurality of warping parameters includes an elevation warping parameter and an azimuth warping parameter.

10. The method of claim 1, wherein the calibration audio comprises an audio tone, entertainment audio, a noise burst, and/or a user instruction.

11. An audio system comprising a controller configured to:
render, via an acoustic transducer, calibration audio based on an initial head-related transfer function (HRTF), wherein the initial HRTF corresponds to an initial azimuth angle and an initial elevation angle and comprises one or more HRTF filters corresponding to a user;
generate a calibrated HRTF based on applying a warping parameter to least one of the initial azimuth angle, the initial elevation angle, and the initial HRTF; and
render, via the acoustic transducer, the calibrated spatialized audio based on the calibrated HRTF and output audio data.

12. The audio system of claim 11, wherein the calibrated HRTF is generated by:
generating a warped azimuth angle based on the initial azimuth angle and the warping parameter;
generating a warped elevation angle based on the initial elevation angle and the warping parameter; and
retrieving the calibrated HRTF based on the warped azimuth angle and the warped elevation angles.

13. The audio system of claim 11, wherein the initial azimuth angle and the initial elevation angle are determined based on head orientation data, head location data, and/or virtual sound source location data.

14. The audio system of claim 11, further comprising a user interface configured to receive the warping parameter provided in response to the calibration audio.

15. The audio system of claim 14, wherein the user interface displays a warping slider configured to capture the warping parameter.

16. The audio system of claim 14, wherein the user interface displays a two-dimensional warping field configured to capture the warping parameter.

17. The audio system of claim 14, wherein the user interface displays a tournament interface configured to capture the warping parameter.

18. The audio system of claim 17, wherein the warping parameter comprises a plurality of warping parameters.

19. The audio system of claim 18, wherein the plurality of warping parameters includes an elevation warping parameter and an azimuth warping parameter.

20. The audio system of claim 11, wherein the calibration audio comprises an audio tone, entertainment audio, a noise burst, and/or a user instruction.
